(19) United States
(12) Patent Application Publication
(10) Pub. No.: US 2025/0285190 A1
(43) Pub. Date: Sep. 11, 2025

(54) Artificial Intelligence Systems and Methods for Automatic Property Damage Estimate Generation and Contents Pricing from Textual and Image Data

(71) Applicant: Xactware Solutions, Inc., Lehi, UT (US)

(72) Inventors: Jeffery D. Lewis, Orem, UT (US); Jeff Young, South Jordan, UT (US); Aaron C. Brunko, Lindon, UT (US); Jonathan Marin, Irmo, SC (US)

(73) Assignee: Xactware Solutions, Inc., Lehi, UT (US)

(21) Appl. No.: 19/073,732

(22) Filed: Mar. 7, 2025

Related U.S. Application Data
(60) Provisional application No. 63/562,465, filed on Mar. 7, 2024.
(60) Provisional application No. 63/701,851, filed on Oct. 1, 2024.

(51) Int. Cl. G06Q 40/08

(52) U.S. Cl. CPC G06Q 40/08

(57) ABSTRACT

Artificial intelligence systems and methods are provided for automatic property damage estimate generation and contents pricing from textual and image data. The system generates an initial prompt for submission to an AI model and modifies the prompt to include additional information relating to historical claims data, property data, and/or other data. The system then submits the modified prompt to one or more AI models along with one or more of textual data and photo data. Output of the AI model(s) is then processed by the system to generate a damage estimate, which could be delivered in the form of natural language output, lists, and/or category and selector codes operable with a software-based insurance claims processing system. Additionally, the system can process textual and/or video (e.g., photo) information in order to automatically generate a list of contents and associated prices, using one or more custom-trained AI models.

### RELATED APPLICATIONS

This application claims priority to U.S. Provisional Patent Application No. 63/562,465 filed on Mar. 7, 2024, and U.S. Provisional Patent Application No. 63/701,851 filed on Oct. 1, 2024, the entire disclosures of which are hereby expressly incorporated by reference.

### BACKGROUND

### Technical Field

The present disclosure relates generally to the field of artificial intelligence. More specifically, the present disclosure relates to artificial intelligence systems and methods for automatic property damage estimate generation and contents pricing from textual and image data.

### Related Art

In the field of insurance claims processing, software-based claims estimation systems are of significant importance in properly and timely processing of insurance claims. Even though such software systems significantly aid insurance adjusters and other professionals with processing insurance claims, the overall process of insurance claims processing can be time-consuming, cumbersome, and prone to human errors. Indeed, much of the usefulness of such systems depends largely on the quality and timeliness of information input into such systems. If inaccurate or incomplete information is provided to such systems, the resulting damage estimates can also be inaccurate or incomplete.

Generative artificial intelligence (AI) is a growing field of interest to the computer science and software engineering communities. Generative AI systems include various computer models that are often trained using massive corpuses of data, and which can generate content of various forms (e.g., textual output, images, videos, sound, etc.) in response to “prompts” or queries submitted to such models. Such systems currently find use in a wide variety of applications, such as recommendation systems, “chatbots,” and other applications. One area where generative AI has not found much application is the field of insurance claims processing generally, and more particularly, applications which utilize generative AI technologies to solve the aforementioned drawbacks of existing software-based insurance claims processing systems.

Accordingly, what would be desirable, but has not yet been provided, are artificial intelligence systems and methods for automatic property damage estimate generation and contents pricing from textual and image data which solve the foregoing and other needs.

### SUMMARY

The present disclosure relates to artificial intelligence systems and methods for automatic property damage estimate generation and contents pricing from textual and image data. The system generates an initial prompt for submission to an AI model and modifies the prompt to include additional information relating to historical claims data, property data, and/or other data. The system then submits the modified prompt to one or more AI models along with one or more of textual data (e.g., a narrative written by a policyholder or adjuster) and photo data (e.g., one or more photos depicting and/or relating to damaged property/items). Output of the AI model(s) is then processed by the system to generate a damage estimate, which could be delivered in the form of natural language output, lists, and/or category and selector codes operable with a software-based insurance claims processing system. Additionally, the system can process textual and/or video (e.g., photo) information in order to automatically generate a list of contents and associated prices, using one or more custom-trained AI models.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating one configuration of the system of the present disclosure;

FIG. 2 is a flowchart illustrating a method for developing one or more prompts to be processed by the system;

FIG. 3 is flowchart illustrating a method for processing textual data and one or more prompts to generate a damage estimate for a property;

FIG. 4 is flowchart illustrating a method for processing photo data and one or more prompts to generate a damage estimate for a property;

FIG. 5 is flowchart illustrating a method for processing textual data, photo data, and one or more prompts to generate a damage estimate for a property;

FIG. 6 illustrates an example of textual data capable of being processed by the system, in the form of a policyholder textual narrative;

FIG. 7 illustrates an example of textual data capable of being processed by the system, in the form of an adjuster textual narrative;

FIG. 8 illustrates an example of a damage estimate generated by the system in the form of natural language output;

FIG. 9 illustrates an example of a damage estimate generated by the system in the form category and selector codes operable with a software-based insurance claims estimation system;

FIG. 10 illustrates an example of property data capable of being processed by the system;

FIGS. 11A-11C illustrate an example of aerial data capable of being processed by the system;

FIG. 12 illustrates an example of claims data capable of being processed by the system;

FIG. 13 is a flowchart illustrating another embodiment of the systems and methods of the present disclosure, wherein building contents are automatically identified and priced;

FIG. 14 is a flowchart illustrating another embodiment of the systems and methods of the present disclosure, wherein building contents are automatically identified and priced; and

FIG. 15 is a screenshot illustrating a user interface screen in accordance with the present disclosure for activating the automatic building contents identification and pricing features of the present disclosure discussed in connection with FIGS. 13-14.

### DETAILED DESCRIPTION

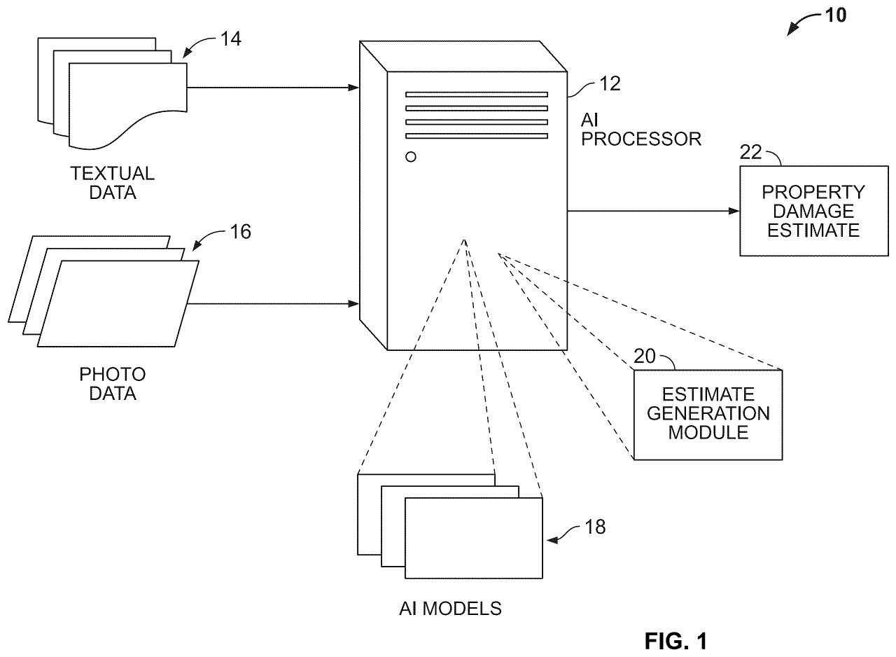

The present disclosure relates to artificial intelligence systems and methods for automatic property damage estimate generation and contents pricing from textual and image data, as described in detail below in connection with FIGS. 1-15.

FIG. 1 is a diagram illustrating one configuration of the system of the present disclosure, indicated generally at 10. The system 10 includes an artificial intelligence (AI) processor 12 that receives as input and processes one or more of textual data 14 and photo data 16, and generates a property damage estimate 12. More specifically, the processor 12 executes and applies one or more pre-trained AI models 18 to the textual data and photo data 16, and outputs of the one or more models 18 are processed by an estimate generation software module 20 to generate the estimate 22. The AI processor 12 could be any suitable, programmed computer system capable of executing the models 18 and the module 20, including, but not limited to, a personal computer, a server, a cloud computing platform, a mobile computing device (e.g., a smart phone, tablet computer, laptop computer, etc.), or other suitable computing device. Moreover, the AI processor 12 could be embodied as a hardware device such as a hardware AI processor, microprocessor, microcontroller, application-specific integrated circuit (ASIC), field-programmable gate array (FPGA), central processing unit (CPU), graphics processing unit (GPU), tensor processing unit (TPU), or any other suitable hardware device.

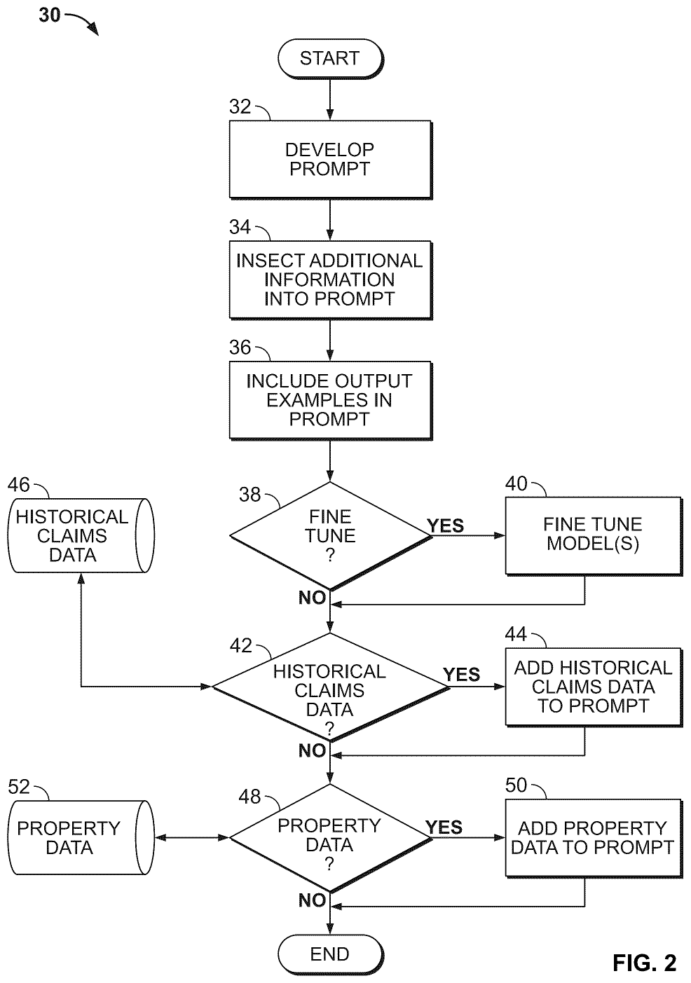

The AI models 18 could include, but are not limited to, the GPT 3.5 and GPT 4 AI models developed by OpenAI, the Llama and Llama2 AI models developed by Meta, theLaMDA, PaLM, PaLM2, and Gemini models developed by Google, the Claude and Claude2 AI models developed by Anthropic, the LLaVA AI model developed by the University of Wisconsin, the Mistral AI model developed by Mistral AI, or any other suitable AI models. Such models 18 could be stored on and executed by the AI processor 12, and/or they could be stored on and executed by another device in communication with the processor 12, such as a cloud-based computing platform, chatbot platform, or other device/service. The damage estimate generation module 20 is programmed in accordance with the processing steps discussed herein in connection with FIGS. 2-5, and could be embodied as computer readable-instructions stored on a non-transitory, computer-readable storage medium forming part of, and/or in communication with, the AI processor 12, including, but not limited to, random-access memory (RAM), read-only memory (ROM), flash memory, disk memory, or any other suitable storage medium. Moreover, the module 20 could be programmed using any suitable high- or low-level programming language including, but not limited to, C, C++, C#, Java, JavaScript, Go, Python, or other suitable programming language.

FIG. 2 is a flowchart illustrating a method, indicated generally at 30, that may be carried out by the system of the present disclosure for developing one or more prompts to be processed by the system. In step 32, the system develops an initial prompt to be utilized as the starting point for processing by one or more of the models 18 of FIG. 1. The prompt can be any form of text, question, information, or coding that communicates to the one or more models 18 a response that is being requested by a user. Next, in step 34, the system injects placeholders into the prompt that can be substituted with additional information to be included in the prompt at specific locations, such as historical claims information or property information. In step 36, the system modifies the prompt to include one or more inputs and/or one or more output examples that are expected in a response generated by the system. Such examples can be “one shot” (wherein one output example is provided in the prompt) or “few shot” or “multi shot” (wherein more than one output example is provided in the prompt). In step 38, a decision is made as to whether to fine tune the prompt. If so, step 40 occurs, wherein the model is fine tuned to provide results specifically tailored for a desired response to the prompt. In this step, additional training could be provided to one or more of the models 18 so that it responds in a specific way, using prompt engineering techniques and/or Retrieval-Augmented Generation (“RAG”). Prompt engineering can involve iterative changes to the prompt, and RAG can involve retrieving data from a database (generally, but not necessarily, a vector database) and inject that data into the prompt. Further, it is noted that a large language model (LLM) could be utilized in the first instance to generate the initial prompt noted in connection with step 32.

In step 42, a determination is made as to whether to add historical claims data to the prompt. If so, step 44 occurs, wherein historical claims data obtained from a database 46 is added to the prompt. Finally, in step 48, a determination is made as to whether to add property data to the prompt. If so, step 50 occurs, wherein property data is obtained from the database 52 and added to the prompt.

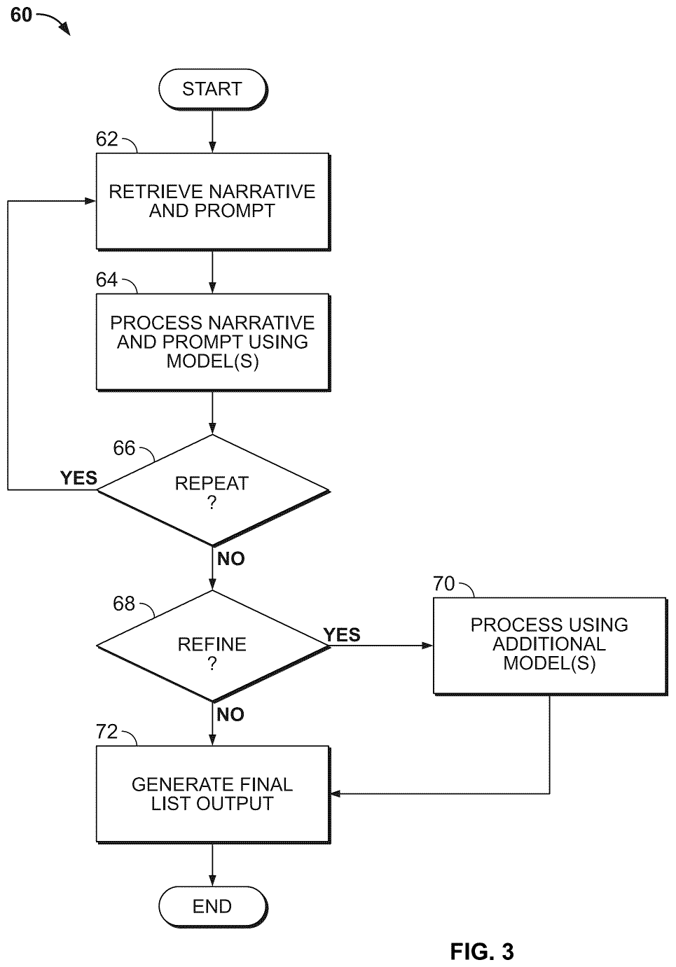

FIG. 3 is flowchart illustrating a method, indicated generally at 60, that may be carried out by the system of the present disclosure, wherein the system processes textual data and one or more prompts to generate a damage estimate for a property. In step 62, the system retrieves textual data (e.g., the textual data 14 of FIG. 1), which can be in the form of a narrative describing and/or relating to an insurance claim event. The narrative could emanate from a policyholder or an adjuster, and details damages to a property. Next, in step 64, the prompt generated by the processing steps of FIG. 2 discussed above, as well as the narrative, are fed to one or more of the AI models 18 and processed thereby, such that the models 18 generate output information in accordance with the prompt. In step 66, a determination is made as to whether to repeat steps 62-64 for additional narratives, models, and/or prompts. If so, steps 62 and 64 are repeated.

In step 68, a determination is made as to whether to refine or correct the output generated by the one or more models 18. If so, step 70 occurs, wherein the output of the model and the prompt are fed to an additional model to generate the refinement or correction. Finally, in step 72, the system generates a final damage estimate for a particular insurance claim. The output could be in the form of a list of items that were damaged, destroyed or affected (and which require repair or replacement), and could be structured either: as natural language descriptions and quantities, or categories and selector codes that are operable with a software-based insurance claims processing system (such as, but not limited to, the XACTIMATE insurance claims processing system by Xactware Solutions, Inc.). Additionally, the output could be in the form of a sketch, which could be saved in a suitable format, such as XML or other format. If the output is in the form of natural language descriptions and quantities, the list could be passed through a converter that converts the list into categories and selector codes, if desired. The categories and selector codes could then be matched to relevant prices lists and the results displayed to the user.

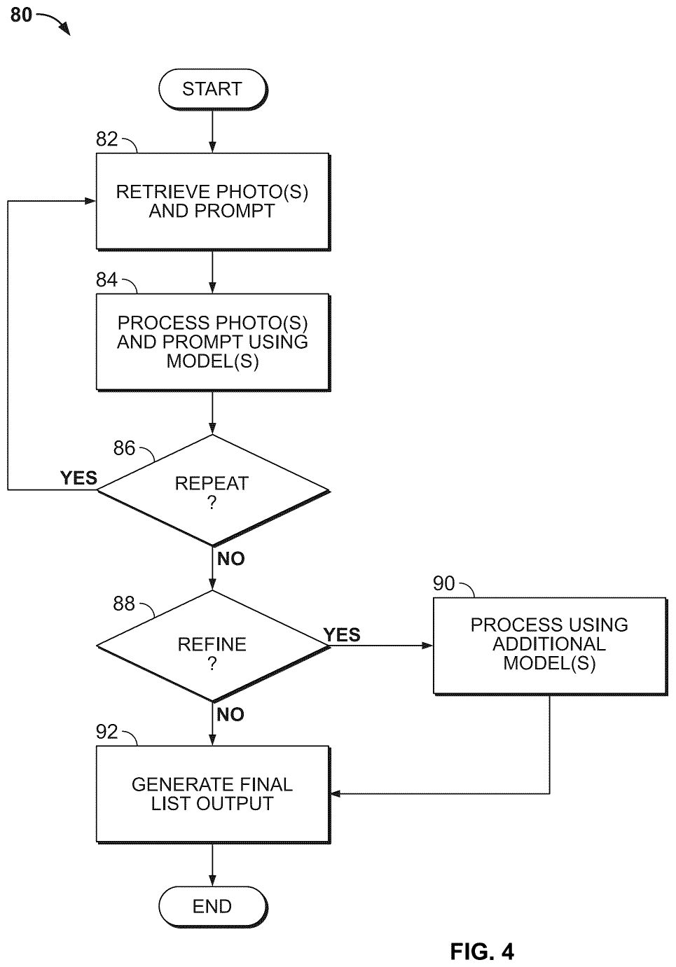

FIG. 4 is flowchart illustrating a method, indicated generally at 80, that may be carried out by the system of the present disclosure, wherein the system processes photo data and one or more prompts to generate a damage estimate for a property. In step 82, the system retrieves photo data (e.g., the photo data 16 of FIG. 1), which can be in the form of one or more photos depicting and/or relating to a damaged property, structure, or item. Next, in step 84, the prompt generated by the processing steps of FIG. 2 discussed above, as well as the photo data, are fed to one or more of the AI models 18 and processed thereby, such that the models 18 generate output information in accordance with the prompt. In step 86, a determination is made as to whether to repeat steps 82-84 for additional narratives, models, and/or prompts. If so, steps 82 and 84 are repeated.

In step 88, a determination is made as to whether to refine or correct the output generated by the one or more models 18. If so, step 90 occurs, wherein the output of the model and the prompt are fed to an additional model to generate the refinement or correction. Finally, in step 92, the system generates a final damage estimate for a particular insurance claim. The output could be in the form of a list of items that were damaged, destroyed or affected (and which require repair or replacement), and could be structured either: as natural language descriptions and quantities, or categories and selector codes that are operable with a software-based insurance claims processing system (such as, but not limited to, the XACTIMATE insurance claims processing system by Xactware Solutions, Inc.). If the output is in the form of natural language descriptions and quantities, the list could be passed through a converter that converts the list into categories and selector codes, if desired. The categories and selector codes could then be matched to relevant prices lists and the results displayed to the user.

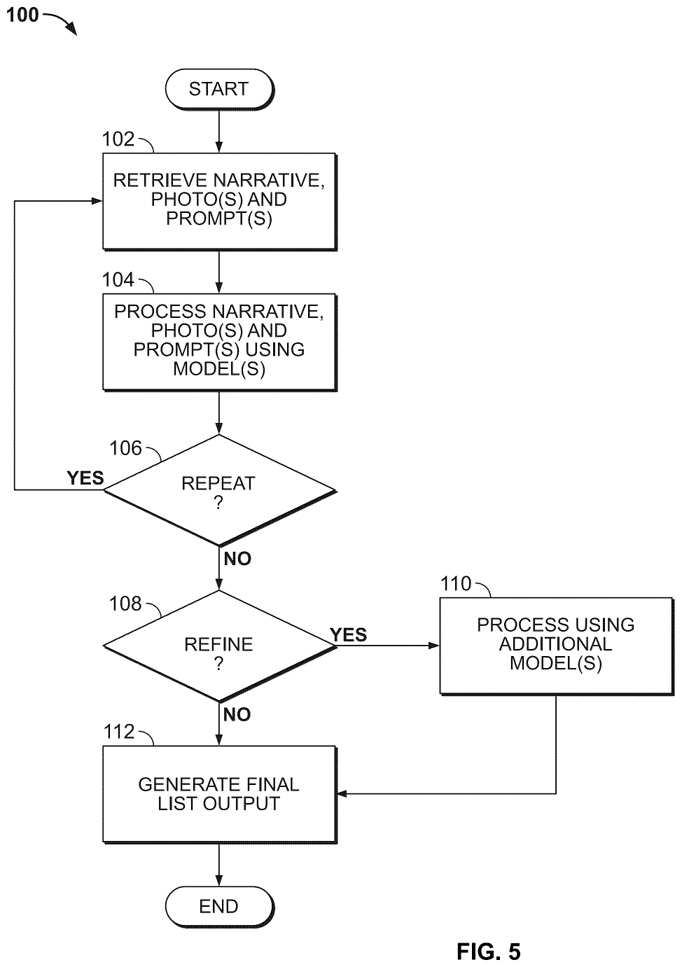

FIG. 5 is flowchart illustrating a method, indicated generally at 100, that may be carried out by the system of the present disclosure, wherein the system processes textual data, photo data, and one or more prompts to generate a damage estimate for a property. In step 102, the system retrieves textual data (e.g., the textual data 14 of FIG. 1), which can be in the form of a narrative describing and/or relating to an insurance claim event and photo data (e.g., the photo data 16 of FIG. 1, which could be one or more photos of damage). The narrative could emanate from a policyholder or an adjuster, and details damages to a property. Next, in step 104, the prompt generated by the processing steps of FIG. 2 discussed above, as well as the narrative and the photo data, are fed to one or more of the AI models 18 and processed thereby, such that the models 18 generate output information in accordance with the prompt. In step 106, a determination is made as to whether to repeat steps 102-104 for additional narratives, models, and/or prompts. If so, steps 102 and 104 are repeated.

In step 108, a determination is made as to whether to refine or correct the output generated by the one or more models 108. If so, step 110 occurs, wherein the output of the model and the prompt are fed to an additional model to generate the refinement or correction. Finally, in step 102, the system generates a final damage estimate for a particular insurance claim. The output could be in the form of a list of items that were damaged, destroyed or affected (and which require repair or replacement), and could be structured either: as natural language descriptions and quantities, or categories and selector codes that are operable with a software-based insurance claims processing system (such as, but not limited to, the XACTIMATE insurance claims processing system by Xactware Solutions, Inc.). If the output is in the form of natural language descriptions and quantities, the list could be passed through a converter that converts the list into categories and selector codes, if desired. The categories and selector codes could then be matched to relevant prices lists and the results displayed to the user.

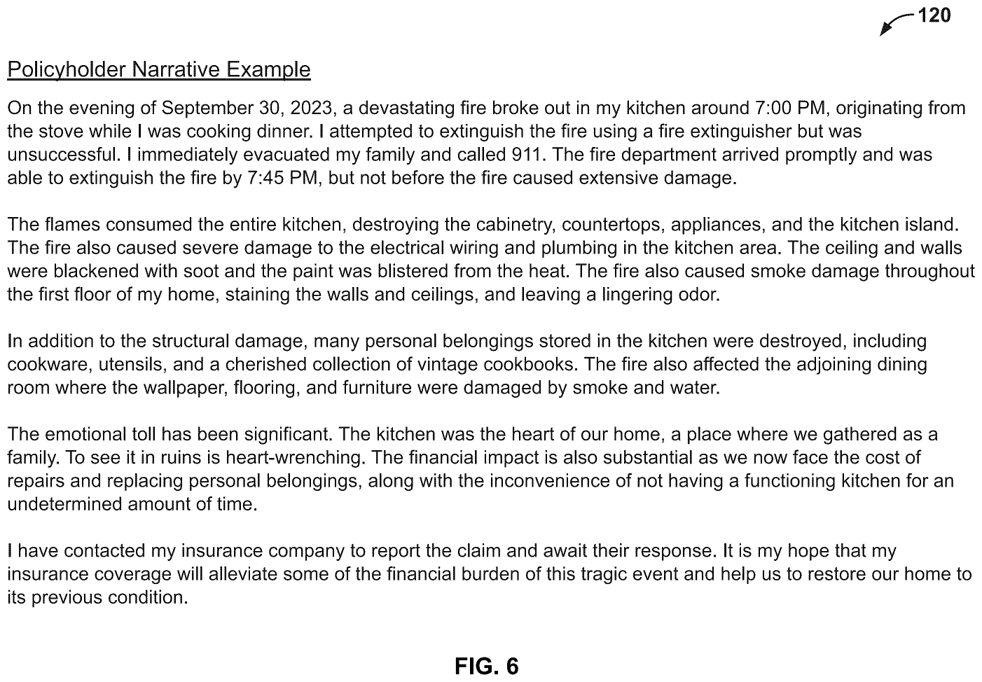

FIG. 6 illustrates an example of textual data capable of being processed by the system, in the form of a policyholder textual narrative indicated at 120. As can be seen, the narrative 120 includes detailed information about an event that gave rise to the insurance claim, as well as other observations, impressions, and/or emotions of the policyholder and actions taken thus far by the policyholder to report a claim and the status of same.

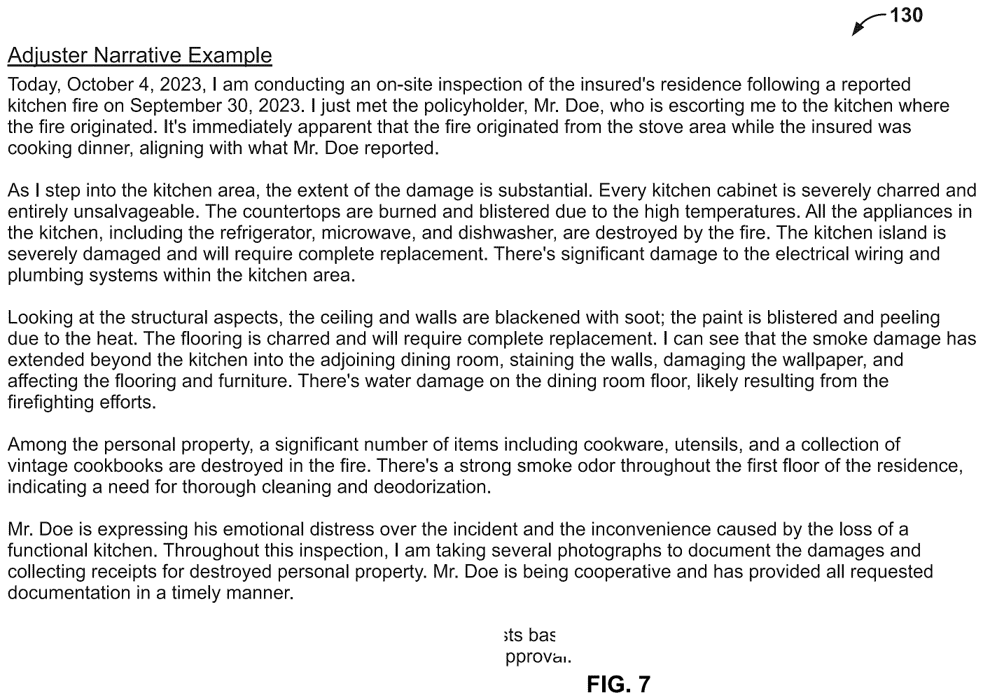

FIG. 7 illustrates an example of textual data capable of being processed by the system, in the form of an adjuster textual narrative indicated at 130. As can be seen, the narrative 130 includes detailed information about an on-site inspection carried out by the adjuster, as well as damage observed by the adjuster and other information (e.g., descriptions of conversations that the adjuster had with the insured, steps being taken to process the claim, etc.).

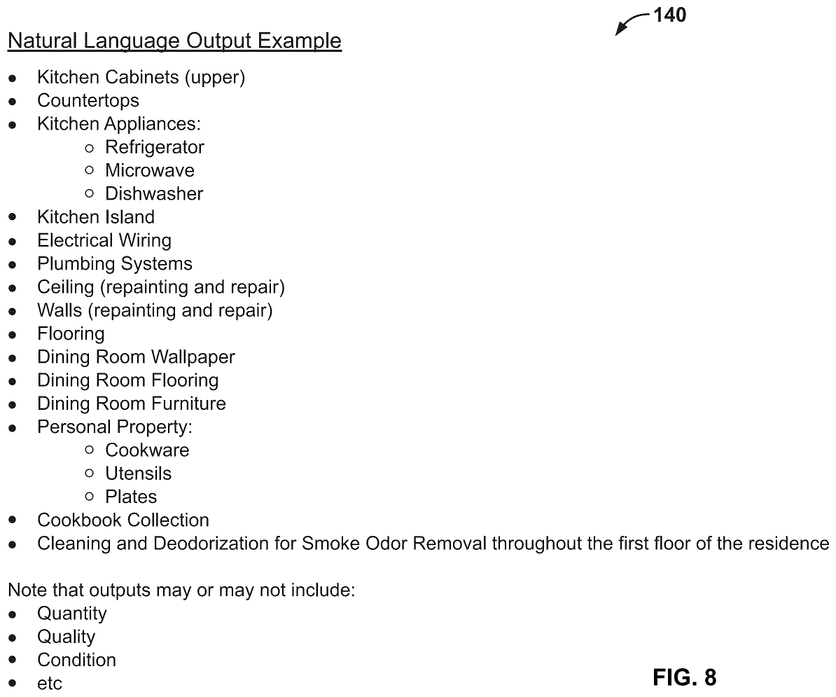

FIG. 8 illustrates an example of a damage estimate generated by the system in the form of natural language output, indicated generally at 140. The natural language output includes specific keywords that inventory specific damaged items associated with an insurance claim (e.g., cabinets, countertops, appliances, islands, wiring, plumbing systems, ceilings, walls, flooring, wallpaper, furniture, personal property, cookbooks, and other information). Additionally, the outputs could include indications of the quantity of each item, the quality of each item, the condition of each item, and other information.

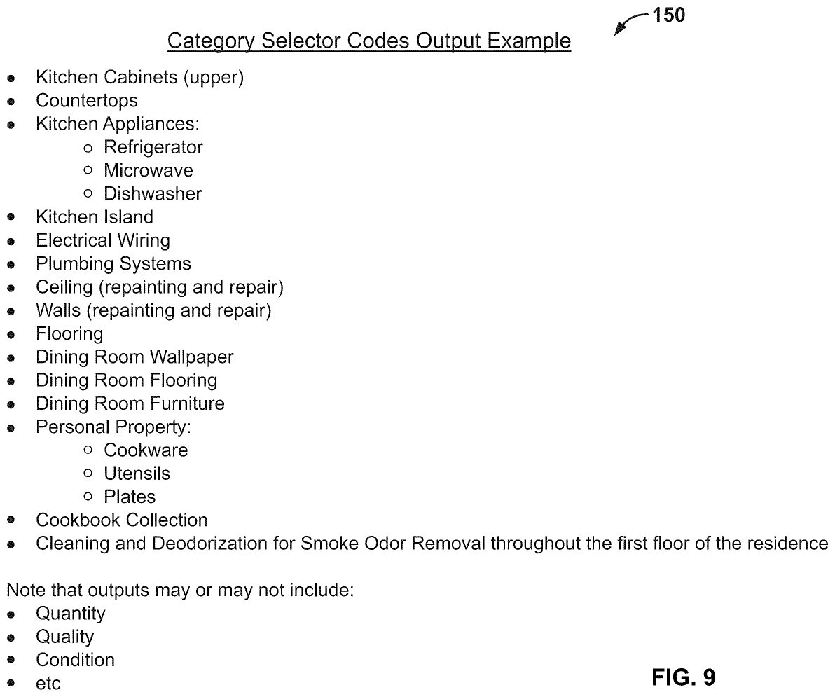

FIG. 9 illustrates an example of a damage estimate generated by the system in the form category and selector codes operable with a software-based insurance claims estimation system, indicated generally at 150. As noted above, the category and selector codes are operable with a software-based insurance claims processing system (such as, but not limited to, the XACTIMATE insurance claims processing system by Xactware Solutions, Inc.), and could include, but are not limited to categories and/or selector codes associated with cabinets, countertops, appliances, islands, wiring, plumbing systems, ceilings, walls, flooring, wallpaper, furniture, personal property, cookbooks, and other information). Additionally, the outputs could include indications of the quantity of each item, the quality of each item, the condition of each item, and other information.

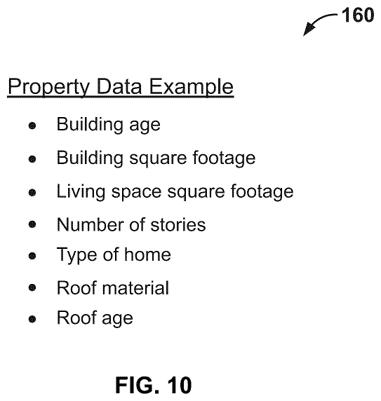

FIG. 10 illustrates property an example of data, indicated generally at 160, capable of being processed by the system. Examples of such data include, but are not limited to, building age, building square footage, living space square footage, number of stories, type of home, roof material, and roof age. The property data could be stored in the property database 52 of FIG. 2 and accessed by the system.

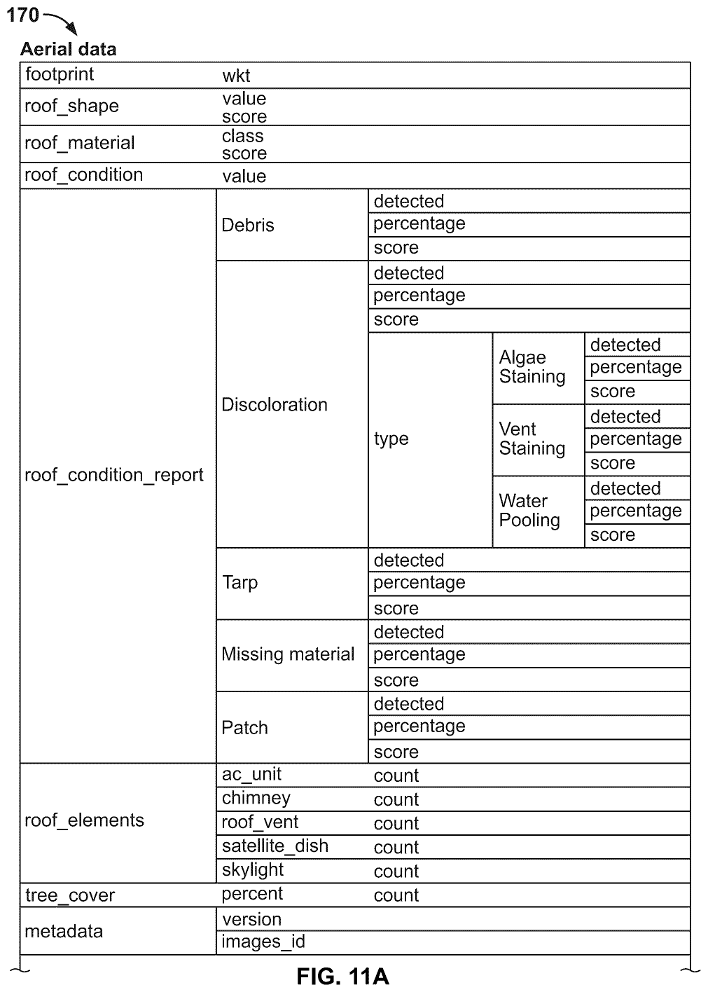

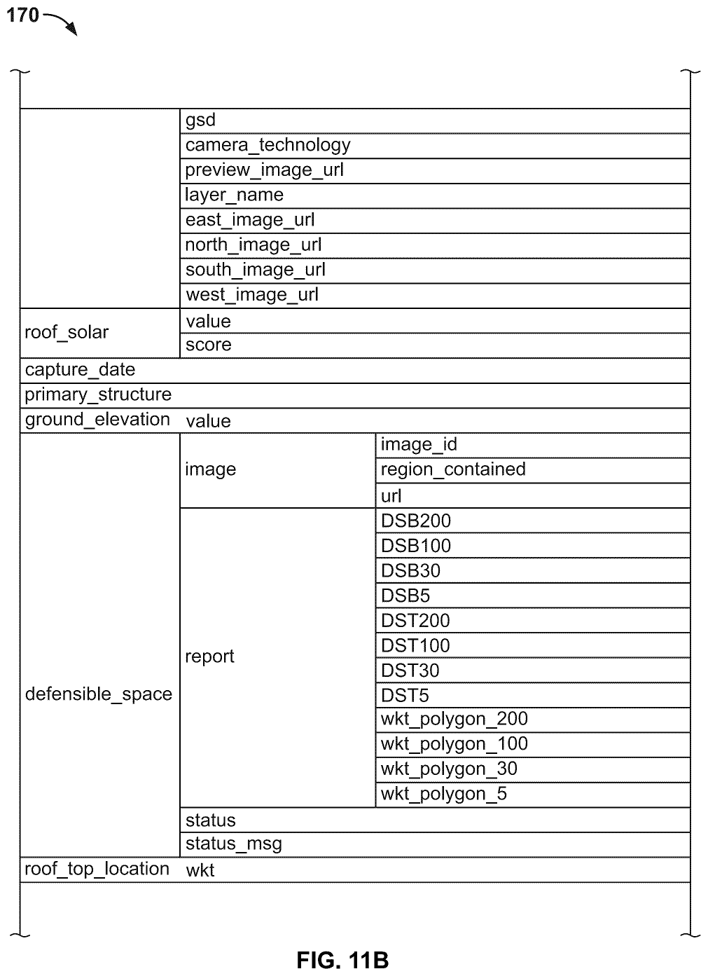

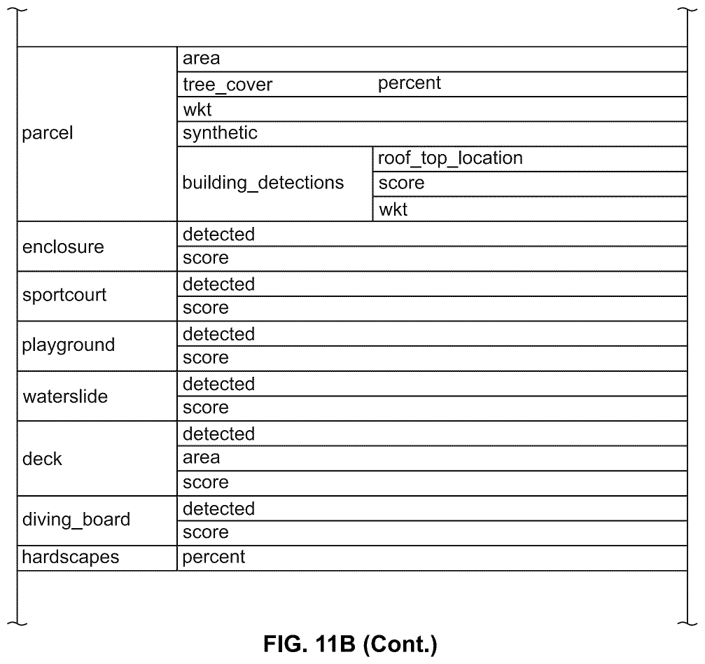

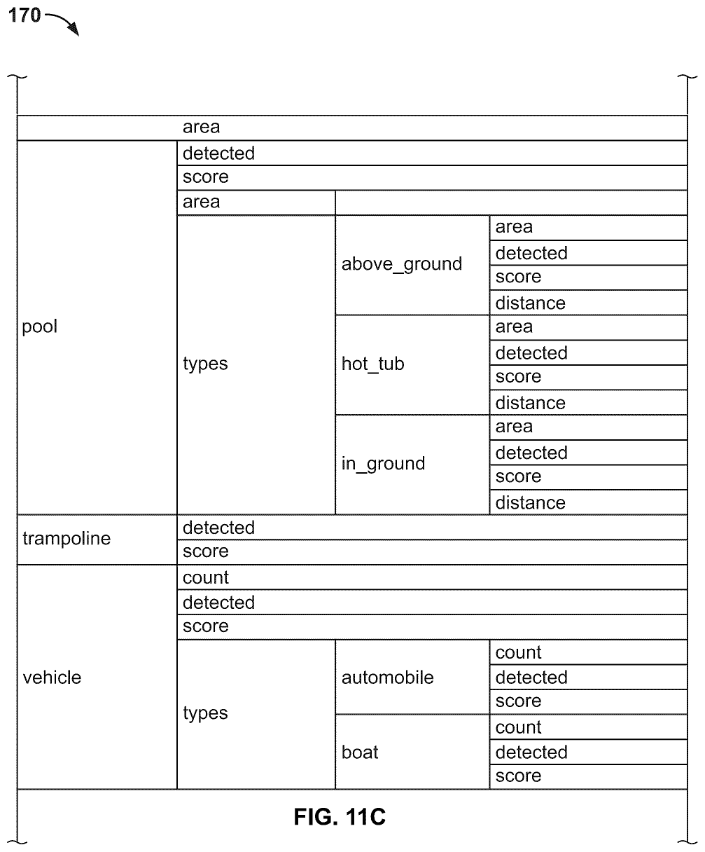

FIGS. 11A-11C illustrate examples of aerial data, indicated generally at 170, capable of being processed by the system. The aerial data 170 could be used to supplement a prompt generated by the system, as noted above, and includes, but is not limited to, the following data: roof shape, roof material, roof condition, roof condition report(s), roof elements, tree cover information, image metadata, solar panel information, image capture date, primary structure identification, ground elevation, defensible space, roof top location, parcel information, enclosure information, counts relating to sporting equipment, playground identification, water slide identification, deck identification, diving board identification, hardscapes, pool information, trampoline detection, and vehicle information.

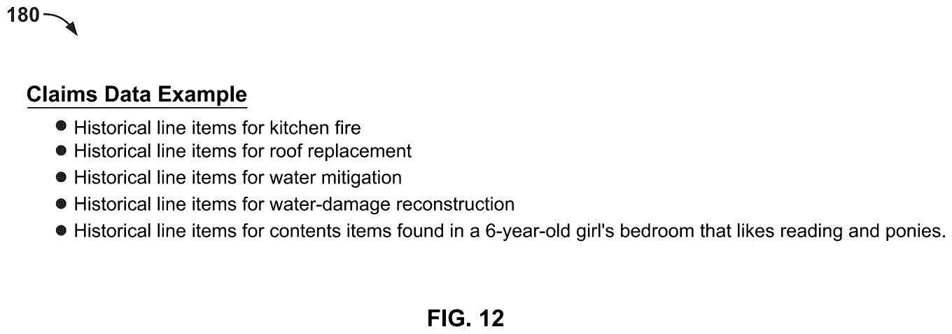

FIG. 12 illustrates an example of claims data, indicated generally at 180, capable of being processed by the system. The claims data can include, but is not limited to, historical line items for various types of events such as kitchen fires, roof replacements, water mitigation events, water damage reconstruction, and other information (e.g., information relating to contents, such as items found in a 6-year-old girl's bedroom, wherein the girl likes reading and ponies).

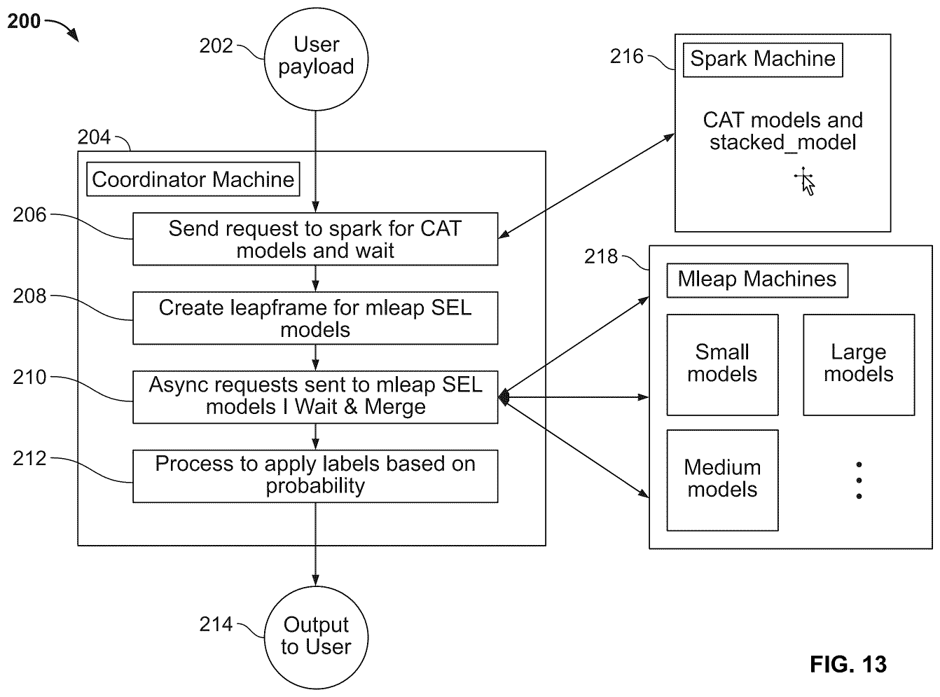

FIG. 13 is a flowchart, indicated generally at 200, illustrating another embodiment of the systems and methods of the present disclosure, wherein building contents are automatically identified and priced. Beginning in step 202, the system receives user payload data, which could include, but is not limited to, an applications programming interface (API) call that transmits one or more items of textual and/or image data relating to an insurance claim. In step 204, a coordinator process (“machine”) is executed on the user payload data. More specifically, in step 206, the system sends a request to an insurance claims processing software system/platform to obtain one or more category (“CAT”) models. Such models could be obtained from a suitable data analytics processing platform (machine) 216 as indicated in FIG. 13, such as the Apache Spark unified analytics engine or other suitable analytics engine that could be utilized to host the aforementioned category models. Next, in step 208, the system creates a lightweight data frame (“leapframe”) that can be used with one or more selector (“SEL”) models associated with the insurance claims processing software system/platform. Such a leapframe could be created using the “MLeap” common serialization format and execution engine for machine learning pipelines (also part of the Apache Spark analytics engine), or other suitable engine.

In step 210, the system sends one or more asynchronous requests to the Mleap SEL models, waits for a response from the models, and then merges data received from the SEL models. Such SEL models could include small, medium, and large models, and could be hosted by one or more MLeap processors (machines) 218. Next, in step 212, the system executes a process that applies labels to the user data (such as names of the contents of the building as well as associated prices), based on probabilities calculated using the CAT and SEL models. Specifically, the system predicts the SEL by an index that has no business-friendly name, and the index is then mapped to a business-friendly label name that corresponds to a predicted SEL code. An example of this includes turning index “0” to a label selector of “FURN” (Furniture) under the “ANT” (Antique) category. Thereafter, once the predicted CAT/SEL code is determined, a probability output is also provided from the model, which takes into account the distribution of probabilities for correct and incorrect classifications to determine what would be a low, medium, or high probability for a given CAT/SEL prediction. For example, above a 50% percentile for a correct prediction equates to a probability between 1 and 0.895 and would signify a high probability for a given CAT/SEL prediction. Between 0.895 and 0.591 would correspond to a medium probability, and anything equal to or lower than 0.591 would correspond to a low probability. The probability numbers can be different and are not static for different CAT/SEL predictions, and are solely for purposes of illustration. Finally, in step 214, the system outputs the labels and associated user data, which includes a list of building contents that were detected by the models as well as associated prices. Such information can then be utilized by an insurance claims processing system to automatically populate an insurance claim with the detected building contents and associated prices.

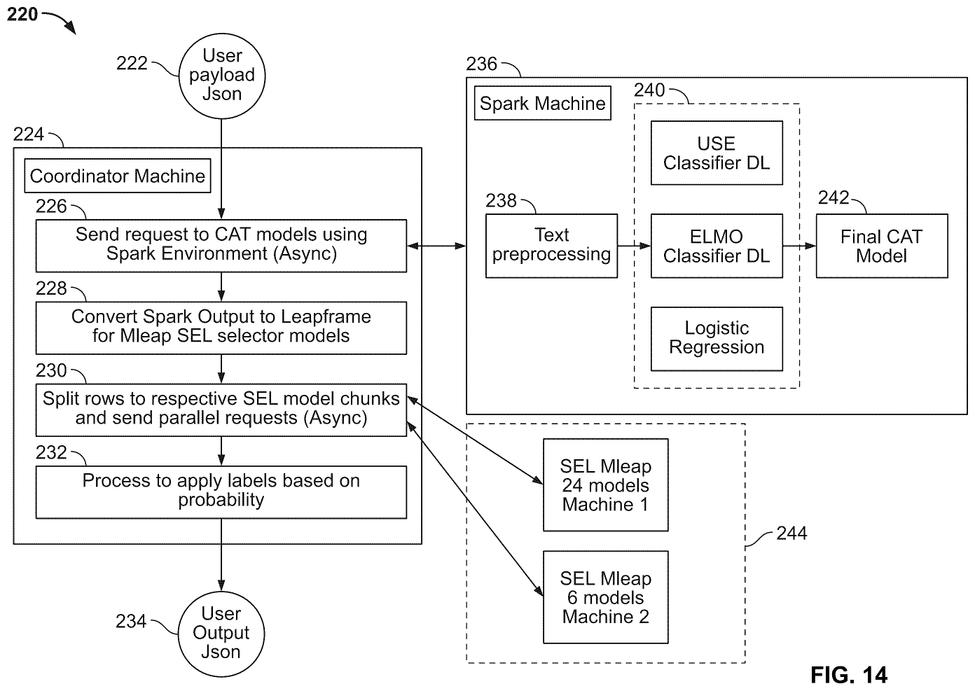

FIG. 14 is a flowchart, indicated generally at 220, illustrating another embodiment of the systems and methods of the present disclosure, wherein building contents are automatically identified and priced. Beginning in step 222, the system receives user payload data, which could include, but is not limited to, an applications programming interface (API) call and/or a Javascript Objet Notation (JSON) message that transmits one or more items of textual and/or image data relating to an insurance claim. In step 224, a coordinator process (“machine”) is executed on the user payload data. More specifically, in step 226, the system sends a request to an insurance claims processing software system/platform to obtain one or more category (“CAT”) models. Such models could be obtained from a suitable data analytics processing platform (machine) 236 as indicated in FIG. 14, such as the Apache Spark unified analytics engine or other suitable analytics engine that could be utilized to host the aforementioned category models.

The data analytics platform 236 could create the one or more CAT models using one or more classifier models 240 (including, but not limited to, a “USE” classifier, an “ELMO” classifier, and a “logistic” classifier) applied to textual claims data that has been preprocessed in step 238, to produce a final CAT model 242. More specifically, in step 238 the following modeling “pipeline” processes occur to predict a CAT code:

(i) The first pipeline uses USE (Universal Sentence Encoder) sentence embeddings that take line item description sentences and transform them to a numeric form for ingestion to a classifier model. The classifier model used in this step is ClassifierDL (DL stands for Deep Learning) that is a Deep Neural Network model for classification. The predicted CAT and the probability is saved.

(ii) The second pipeline uses ELMO word embeddings that take line item descriptions and transform them to a numeric form for ingestion to a classifier model. The classifier model used in this step is ClassifierDL (DL stands for Deep Learning) that is a Deep Neural Network model for classification. The predicted CAT and the probability is saved.

(iii) The third pipeline uses CountVEC and IDF which is a natural language processing (NLPO method to turn line items into numerical data by counting word occurrences and adjusting word importance by downscaling frequent works and upscaling rare words. These numeric features were used in a Logistic Regression model to classify the CAT code and the probability is saved.

(iv) The 3 category predictions discussed in pipeline steps i-iii above and the corresponding predictions are used as data features to determine the final predicted CAT code using a Logistic Regression model.

Next, in step 228, the system creates a lightweight data frame (“leapframe”) that can be used with one or more selector (“SEL”) models associated with the insurance claims processing software system/platform. Such a leapframe could be created using the “MLeap” common serialization format and execution engine for machine learning pipelines (also part of the Apache Spark analytics engine), or other suitable engine. In step 230, the system splits rows into respective SEL chunks and sends the chunks asynchronously (e.g., in parallel) to the SEL models. Such SEL models could include MLeap SEL models 244, which could be hosted by one or more processors (machines). Next, in step 232, the system executes a process that applies labels to the user data (such as names of the contents of the building as well as associated prices), based on probabilities calculated using the CAT and SEL models as discussed in detail above in connection with step 212. Finally, in step 234, the system outputs the labels and associated user data, which includes a list of building contents that were detected by the models as well as associated prices. Such information can then be utilized by an insurance claims processing system to automatically populate an insurance claim with the detected building contents and associated prices.

It is noted that the coordinator machines 204 and 224 discussed above can perform asynchronous operations made possible with Fast API implementation. The machines 204, 224 could each comprise a Fargate “serverless” compute engine provided by Amazon, Inc. and having a task memory of 2 GB and a single task central processing unit (CPU), but of course, other types of computing systems/platforms could be utilized. Additionally, the Spark machines 216, 236 could host the Spark infrastructure required to run Spark Natural Language Processing (NLP) models with John Snow Labs package dependency. The Spark engine is sufficiently efficient for large bathc data processing engine requests. To address potential data processing bottlenecks that could arise with multiple concurrent users, the system of the present disclosure implements a pseudo batch processing logic that collects all requests received while the machines 216, 236 are busy and then subsequently submits such requests for processing when the machines 216, 236 are less busy. The individual user requests can be split and sent to individual threads using suitable asynchronous computing techniques, such as the Java 5 “Future” multithreading computation feature. Such an approach reduces average computational wait times for response.

It is further noted that the text preprocessing process 238 of FIG. 14 can combine multiple (e.g., 4) text fields into a single description which is then converted into a Spark-compatible frame. The classifier models 240 can be executed in parallel, and the final CAT model 242 of FIG. 14 combines the outputs of the models 240 to determine the selector category to be used by the Mleap models. The Spark machines 216, 236 could each comprise a Fargate “serverless” compute engine provided by Amazon, Inc. and having a task memory of 30 GB and four (4) task central processing units (CPUs), but of course, other types of computing systems/platforms could be utilized. Still further, the MLeap machines discussed in connection with the models 244 could each be EC2-type machines having 60 GB of task memory and eight (8) task CPUs, but of course, other types of computing systems/platforms could be utilized.

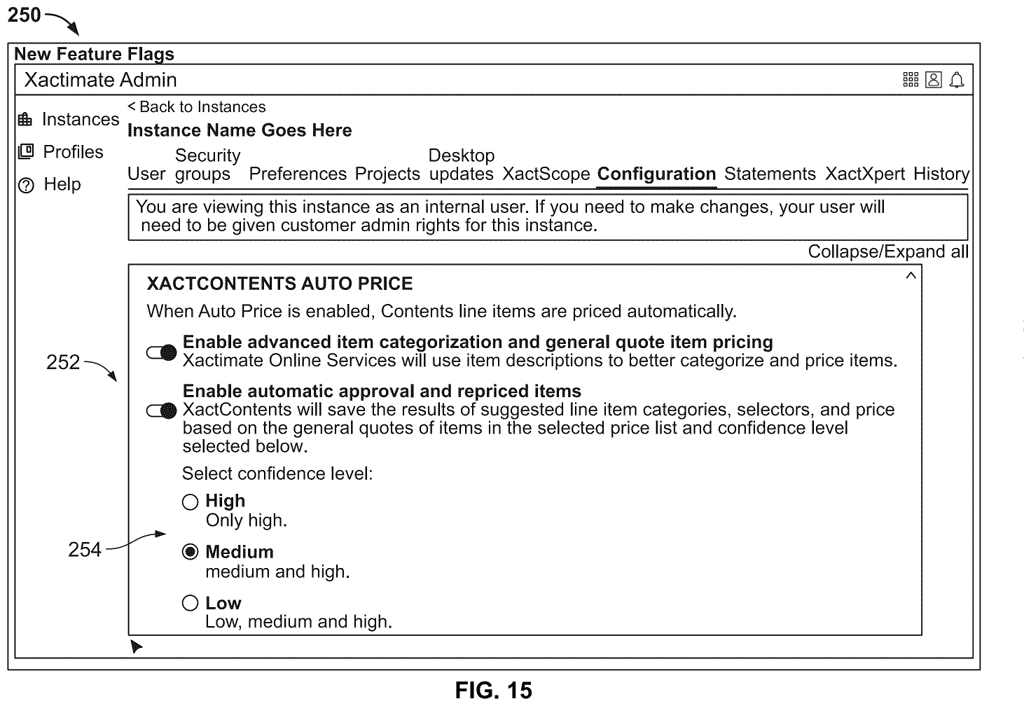

FIG. 15 is a screenshot illustrating a user interface screen, indicated generally at 250, in accordance with the present disclosure for activating the automatic building contents identification and pricing features of the present disclosure discussed in connection with FIGS. 13-14. As can be seen, the screen 250 includes sliders 252 (graphical user interface elements) that allow a user of an insurance claims processing software package (such as the XACTIMATE insurance claims processing platform) to select whether to enable advanced item categorization and general quote item pricing, as well as automatic approval and repriced items. The user can also select a confidence level by activing one of the radio buttons 254 (e.g., low, medium, or high confidence levels). When these controls are activated, the system executes the features discussed in connection with FIGS. 13-14 to automatically identify building contents and price such contents.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. An artificial intelligence system for automatic property damage estimate generation and contents pricing from textual and image data, comprising:
a processor receiving at least one of textual data or photo data; and
an estimate generation software module executed by the processor, the estimate generation software module causing the processor to:
generate a prompt;
inject at least one additional piece of information into the prompt;
process the prompt and at least one of the textual data or the photo data using a first machine learning model to generate output information in accordance with the prompt;
determine whether the output information requires refinement or correction of the prompt;
process the output information and the prompt using a second machine learning model to generate refined or corrected information in response to a determination that the output information requires refinement or correction of the prompt; and
generate a damage estimate based on the refined or corrected information generated by the second machine learning model.

2. The system of claim 1, wherein the at least one additional piece of information comprises historical claims data.

3. The system of claim 1, wherein the at least one additional piece of information comprises property data.

4. The system of claim 1, wherein the textual data comprises a narrative describing or relating to an insurance claim event.

5. The system of claim 1, wherein the photo data comprises one or more photos depicting or relating to a damaged property, structure, or item.

6. The system of claim 1, wherein the damage estimate comprises a list of damaged, destroyed, or affected items.

7. The system of claim 1, wherein the damage estimate comprises one or more of natural language descriptions, quantities, categories, or selector codes operable with a software-based insurance processing claim system.

8. The system of claim 1, wherein the damage estimate comprises a sketch.

9. The system of claim 1, wherein the additional piece of information comprises aerial data.

10. The system of claim 1, wherein the processor automatically identifies and prices building contents from at least one of the textual data or the photo data.

11. An artificial intelligence method for automatic property damage estimate generation and contents pricing from textual and image data, comprising:
receiving at least one of textual data or photo data at a processor;
generating a prompt;
injecting at least one additional piece of information into the prompt;
processing the prompt and at least one of the textual data or the photo data using a first machine learning model to generate output information in accordance with the prompt;
determining whether the output information requires refinement or correction of the prompt;
processing the output information and the prompt using a second machine learning model to generate refined or corrected information in response to a determination that the output information requires refinement or correction of the prompt; and
generating a damage estimate based on the refined or corrected information generated by the second machine learning model.

12. The method of claim 11, wherein the at least one additional piece of information comprises historical claims data.

13. The method of claim 11, wherein the at least one additional piece of information comprises property data.

14. The method of claim 11, wherein the textual data comprises a narrative describing or relating to an insurance claim event.

15. The method of claim 11, wherein the photo data comprises one or more photos depicting or relating to a damaged property, structure, or item.

16. The method of claim 11, wherein the damage estimate comprises a list of damaged, destroyed, or affected items.

17. The method of claim 11, wherein the damage estimate comprises one or more of natural language descriptions, quantities, categories, or selector codes operable with a software-based insurance processing claim system.

18. The method of claim 11, wherein the damage estimate comprises a sketch.

19. The method of claim 11, wherein the additional piece of information comprises aerial data.

20. The method of claim 11, further comprising automatically identifying and pricing building contents from at least one of the textual data or the photo data.
